(19) United States
(12) Patent Application Publication
(10) Pub. No.: US 2009/0067072 A1
(43) Pub. Date: Mar. 12, 2009

(54) PRISM SYSTEM WITH PRISM SPACER

(75) Inventors: CHIA-HUNG KAO, Tu-Cheng (TW); JING-MIAU WU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/961,251

(22) Filed: Dec. 20, 2007

(30) Foreign Application Priority Data
Sep. 7, 2007 (CN) 200710201612.7

(51) Int. Cl. G02B 5/04

(52) U.S. Cl. 359/834; 359/831

(57) ABSTRACT

An exemplary prism system includes a first prism, a second prism, and a spacer. The first prism includes a first conjunction face and the second prism includes a second conjunction face. The first conjunction face and the second conjunction face are opposite each other. The spacer is disposed between the first conjunction face and the second conjunction face. The spacer is made of transparent material having a refractive index lower than that of the first prism and the second prism. Light entering the first prism can be totally reflected inside the prism system before leaving the second prism.

### TECHNICAL FIELD

The present invention relates to a total internal reflection (TIR) prism system that can be used with a digital micromirror device (DMD) and a projector, the prism system reducing loss of incident light therein.

### BACKGROUND

With ongoing developments in display technology, new display means such as digital light projectors (DLPs), liquid crystal on silicon (LCOS), and light emitting diodes (LEDs) are now commercially feasible in the field. In developing new projectors, it is important to provide the projectors with features such as high resolution, excellent contrast, full brightness, and low price.

A conventional digital micromirror device (DMD) projecting system incorporating a conventional total internal reflection (TIR) prism system is shown in FIG. 4. A light source 10 comprises a light bulb 101 and a reflective cup 102. The light bulb 101 emits light 103. A portion of the light 103 is reflected by the reflective cup 102 and focused to transmit through a color wheel 11. The light 103 transmitted through the color wheel 11 then passes through an integration rod 12. The light 103 inside the integration rod 12 undergoes multiple reflections to form a uniform light beam. The light beam passes through lenses 13, 14, and is reflected by a mirror 15 to pass through a lens 16 and a TIR prism system 17. Subsequently, the light beam is reflected to the DMD 18 by the TIR prism system 17. Micromirrors on the DMD 18 can be rotated to a predetermined angle to reflect the light beam to the projecting lens 19. Accordingly, the projecting system projects images on a screen.

Referring also to FIG. 5, the TIR prism system 17 includes a first prism 171 and a second prism 172. The first prism 171 and the second prism 172 have a first conjunction face 1701 and a second conjunction face 1702 respectively. The first conjunction face 1701 and the second conjunction face 1702 are polished and then attached together by applying an adhesive 29. In order to eliminate light refraction of a return light beam inside the TIR prism system 17, a gap is defined between the first conjunction face 1701 and the second conjunction face 1702. Thereby, total internal reflection of the return light beam at the first conjunction face 1701 is achieved. However, if the first conjunction face 1701 and the second conjunction face 1702 are not precisely polished, one or more bumps 173 may be formed on either or both of the first conjunction face 1701 and the second conjunction face 1702. As a result, the first conjunction face 1701 and the second conjunction face 1702 may be nonparallel relative to each other. In addition, the adhesive 29 may shrink over time and make the two conjunction faces 1701, 1702 become nonparallel. In such cases, when an incident light beam transmits through the TIR prism system 17, total internal reflection of the return light beam at the first conjunction face 1701 may not be possible.

Therefore, it is desired to provide a prism system with improved capability of total internal reflection.

### SUMMARY

In accordance with a present embodiment, a prism system including a first prism, a second prism, and at least one spacer is provided. An incident light beam emitted from a light source transmits through the first prism and then enters the second prism. The first prism includes a first conjunction face and the second prism includes a second conjunction face. The first conjunction face and the second conjunction face are opposite each other. At least one spacer is disposed between the first conjunction face and the second conjunction face. The spacer is made of a transparent material having a refractive index lower than that of the first prism and the second prism. The incident light beam can be totally reflected inside the prism system.

Other novel features and advantages will be drawn from the following detailed description of at least one preferred embodiment, when considered in conjunction with the attached drawings.

### BRIEF DESCRIPTION OF THE DRAWINGS

Many aspects of the present prism system can be better understood with reference to the following drawings. The components in the drawings are not necessarily drawn to scale, the emphasis instead being placed upon clearly illustrating the principles of the present prism system. Moreover, in the drawings, like reference numerals designate corresponding parts throughout the several views.

FIG. 1 is a side cross-sectional view of a prism system in a first embodiment of this invention, showing essential optical paths.

FIG. 2 is a side cross-sectional view of a prism system in a second embodiment of this invention, showing essential optical paths.

FIG. 3 is an exploded, isometric view of a prism system in a third embodiment of this invention.

FIG. 4 is essentially a schematic plan view of a conventional DLP projection system, showing essential optical paths thereof.

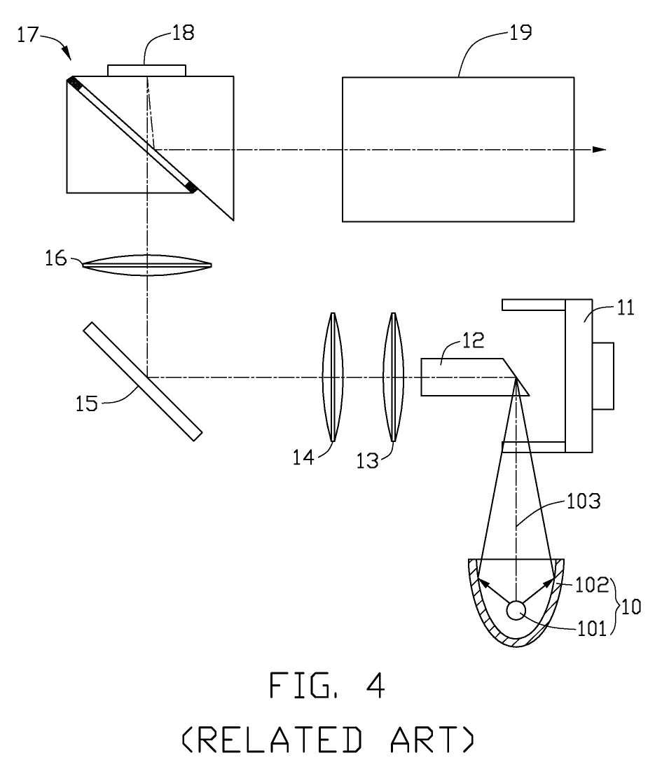

FIG. 5 is an enlarged view of a TIR prism system of the DLP projection system of FIG. 4, showing the TIR prism system rotated 180° from FIG. 4.

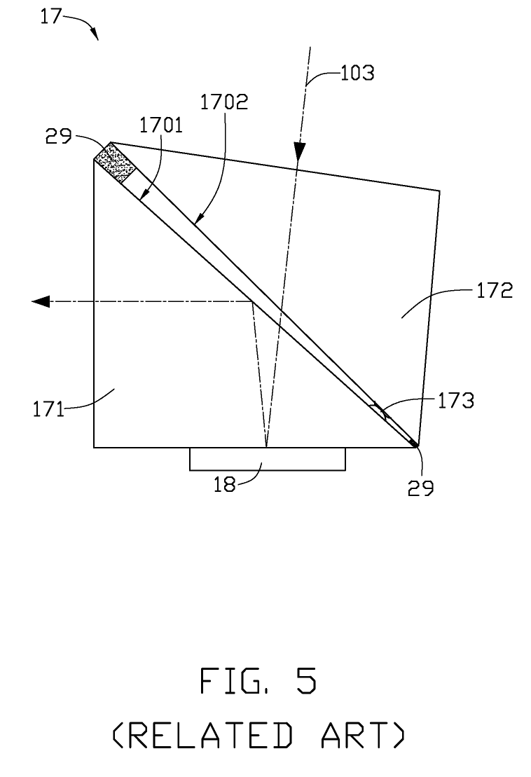

### DETAILED DESCRIPTION OF THE PREFERRED EMBODIMENTS

Embodiments of the present prism system will now be described in detail below and with reference to the drawings.

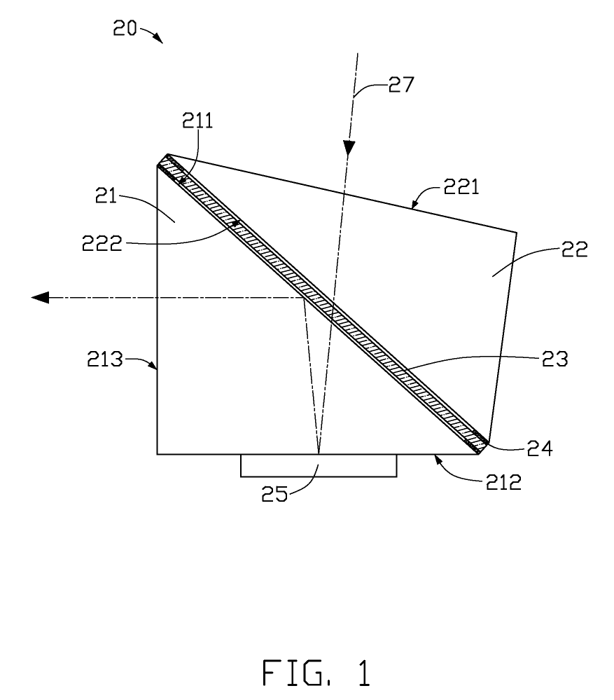

Referring to FIG. 1, a side cross-sectional view of a prism system 20 in accordance with a first present embodiment is shown. The prism system 20 includes a first prism 22, a second prism 21, a spacer 23, and a plurality of adhesive portions 24.

The first prism 22 includes a first face 221 and a first conjunction face 222. An incident light beam 27 emitted from a light source (not shown) transmits through the first face 221 and then is refracted in the first conjunction face 222 to enter the second prism 21. Preferably, the second prism 21 is a right-angled prism, which includes a hypotenuse side as a second conjunction face 211, a first right-angle side as a reflection plane 212, and a second right-angle side as an exit plane 213. The second conjunction face 211 and the first conjunction face 222 are substantially the same in size. In this embodiment, the second conjunction face 211 and the first conjunction face 222 are exactly the same in size. Alternatively, the second conjunction face 211 can be larger in size than the first conjunction face 222.

The spacer 23 in the embodiment is a thin plate of transparent material having a refractive index lower than that of the first prism 22 and the second prism 21. For example, the first prism 22 and the second prism 21 are made of glass, and the spacer 23 is made of another transparent material like fused silica. A length of the spacer 23 is substantially equal to a corresponding length of the first conjunction face 222. Preferably, the spacer 23 and the first conjunction face 222 have the same length. A width of the spacer 23 (in an axis perpendicular to the page of FIG. 1) can be configured according to need. In one embodiment, the width of the spacer 23 is the same as a corresponding width of the first conjunction face 222 such that an area of the spacer 23 is substantially the same as a size of the first conjunction face 222.

The adhesive portions 24 are configured for attaching the spacer 23 between the first conjunction face 222 and the second conjunction face 211. The adhesive portions 24 are typically selected from the group of double-sided tape, contact adhesive, and thermoplastic adhesive. A length of each adhesive portion 24 is a small fraction of a corresponding length of the first conjunction face 222 (see above). A width of each adhesive portion 24 (in the axis perpendicular to the page of FIG. 1) is determined in part by the width of the spacer 23, and can be configured according to need. In one embodiment, the width of each adhesive portion 24 is the same as the width of the spacer 23. Once the prism system 20 is assembled, a thin air gap exists between the second conjunction face 211 and the spacer 23.

A DMD 25 is connected with the prism system 20. The DMD 25 is configured for cooperating with the reflection plane 212 of the second prism 21 to reflect the light beam 27. The DMD 25 rotates within a predetermined range of rotation angles (normally −10 to +10 degrees) to reflect the light beam 27 to the second conjunction face 211. The light beam 27 is then reflected by the second conjunction face 211, and transmits through the exit plane 213 of the second prism 21. Because the refractive index of air in the air gap is lower than that of the second prism 21, the incident light beam 27 can be totally reflected at the second conjunction face 211 to thereupon exit through the exit plane 213. This is because the refractive index of the spacer 23 is lower than that of the second prism 21. Thus the incident light beam 27 can be totally reflected at the second conjunction face 211 to thereupon exit through the exit plane 213.

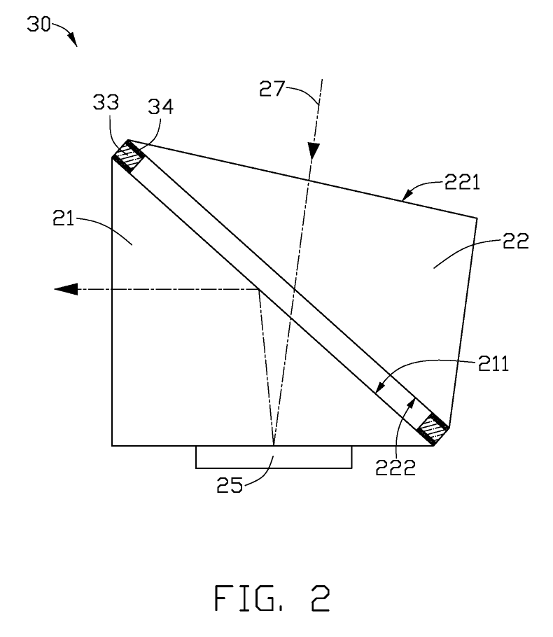

Referring to FIG. 2, a side cross-sectional view of a prism system 30 in accordance with a second present embodiment is shown. The prism system 30 is similar to the prism system 20, but has different spacing means. Two spacers 33 made of transparent material are arranged in the prism system 30. The spacers 33 are disposed at opposite ends of the first conjunction face 222, between these opposite ends and corresponding opposite ends of the second conjunction face 211. The spacers 33 are attached between the first conjunction face 222 and the second conjunction face 211 by a plurality of adhesive portions 34. A length of each spacer 33 is a small fraction of a corresponding length of the first conjunction face 222. Thereby, the spacers 33 do not hinder the light beam 27 from transmitting to the second prism 21. A width of each spacer 33 (in an axis perpendicular to the page of FIG. 2) can be configured according to need. In one embodiment, the width of each spacer 23 is the same as a corresponding width of the first conjunction face 222. A length of each adhesive portion 34 is the same as the length of each spacer 33. A width of each adhesive portion 34 (in the axis perpendicular to the page of FIG. 2) is determined in part by the width of each spacer 33, and can be configured according to need. In one embodiment, the width of each adhesive portion 34 is the same as the width of each spacer 33.

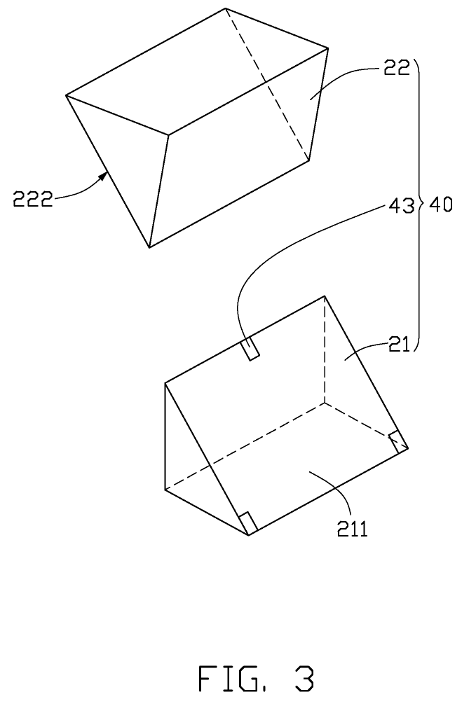

Referring to FIG. 3, an exploded, isometric view of a prism system 40 in accordance with a third present embodiment is shown. The prism system 40 is similar to the prism system 30, but differs at least in the number of spacers. At least three spacers 43 are arranged in the prism system 40. The spacers 43 are made of transparent material. A length and a width of each spacer 43 are a small fraction of a corresponding length and width of the second conjunction face 211. In the illustrated embodiment, the length of each spacer 43 is about twice the width of the spacer 43. The spacers 43 are disposed at edge portions of the second conjunction face 211, and at least one of the spacers 43 is not arranged in a same alignment with two other spacers 43. Preferably, at least two of the spacers 43 are disposed diagonally opposite each other at opposite sides of the second conjunction face 211. By applying an adhesive (not shown) to the spacers 43, the first conjunction face 222 and the second conjunction face 211 are adhered to the spacers 43.

Unlike in conventional art, the spacers in the above-described embodiments can keep the two conjunction faces of the prism system parallel, even over a long period of time. Thereby, total internal reflection in the prism system can be reliably achieved. The optical performance and permanence of the prism system is enhanced.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A prism system comprising:
a first prism having a first conjunction face;
a second prism having a second conjunction face, the first conjunction face and the second conjunction face being generally opposite each other; and
at least one spacer disposed between the first conjunction face and the second conjunction face.

2. The prism system as claimed in claim 1, wherein an area of the at least one spacer is substantially the same as a size of the first conjunction face.

3. The prism system as claimed in claim 1, wherein the at least one spacer is a plate made of transparent material.

4. The prism system as claimed in claim 3, wherein the at least one spacer is attached between the first conjunction face and the second conjunction face by a plurality of adhesive portions.

5. The prism system as claimed in claim 4, wherein the adhesive portions are made of material selected from the group consisting of double-sided tape, contact adhesive, and thermoplastic adhesive.

6. The prism system as claimed in claim 2, wherein the at least one spacer is made of transparent material having a refractive index lower than that of the first prism and the second prism.

7. The prism system as claimed in claim 6, wherein the at least one spacer is made of fused silica.

8. The prism system as claimed in claim 1, wherein the at least one spacer is two spacers.

9. The prism system as claimed in claim 8, wherein the spacers are disposed at opposite ends of the first conjunction face, between these opposite ends and corresponding opposite ends of the second conjunction face.

10. The prism system as claimed in claim 8, wherein a length of each of the spacers is a small fraction of a corresponding length of the first conjunction face.

11. The prism system as claimed in claim 1, wherein the at least one spacer is at least three spacers.

12. The prism system as claimed in claim 11, wherein the spacers are disposed at edge portions of the second conjunction face, and at least one of the spacers is not arranged in a same alignment with two other spacers.

13. The prism system as claimed in claim 12, wherein at least two of the spacers are disposed diagonally opposite each other at opposite sides of the second conjunction face.

14. The prism system as claimed in claim 11, wherein the first conjunction face and the second conjunction face are parallel to each other.

15. A prism system comprising:
a first prism having a first conjunction face;
a second prism having a second conjunction face, the second conjunction face facing toward and being parallel to the first conjunction face;
at least one spacer disposed between the first conjunction face and the second conjunction face; and
a plurality of adhesive portions attaching the at least one spacer between the first conjunction face and the second conjunction face.
